(19) United States
(12) Patent Application Publication
(10) Pub. No.: US 2026/0244244 A1
(43) Pub. Date: Aug. 20, 2026

(54) HEAD-MOUNTED DEVICE

(71) Applicant: VIVO MOBILE COMMUNICATION CO., LTD., Guangdong (CN)

(72) Inventors: Junhui XIAO, Guangdong (CN); Jiantang LIN, Guangdong (CN)

(73) Assignee: VIVO MOBILE COMMUNICATION CO., LTD., Guangdong (CN)

(21) Appl. No.: 19/646,459

(22) Filed: Apr. 13, 2026

Related U.S. Application Data
(63) Continuation of application No. PCT/CN2024/126501, filed on Oct. 22, 2024.

(30) Foreign Application Priority Data
Oct. 25, 2023 (CN) 202311388161.8

(51) Int. Cl. G06F 1/16

(52) U.S. Cl. CPC G06F 1/163

(57) ABSTRACT

A head-mounted device, including: a first assembly, where a display function module is disposed on the first assembly; a second assembly, where an auxiliary module of the display function module is disposed on the second assembly, and the auxiliary module is electrically connected to the display function module; a connecting mechanism, configured to connect the first assembly and the second assembly, where in a case that the head-mounted device is in a first working state, the second assembly is capable of moving relative to the first assembly along the direction of gravity via the connecting mechanism; a first strap, where the first strap is connected to the first assembly; a second strap, where the second strap is connected to the second assembly; and a first connecting member disposed between the first strap and the second strap.

### CROSS-REFERENCE TO RELATED APPLICATIONS

This application is a continuation of International Application No. PCT/CN2024/126501 filed on October 22, 2024, which claims priority to Chinese Patent Application No. 202311388161.8 filed on October 25, 2023, which are incorporated herein by reference in their entireties.

### TECHNICAL FIELD

This application pertains to the technical field of wearable devices, and specifically relates to a head-mounted device.

### BACKGROUND

Augment reality (AR) and virtual reality (VR) are technologies that utilize computer technologies and head-mounted or wearable devices to provide users with sensory experiences such as visual, auditory, and tactile experiences through interaction with real or virtual environments. The VR/AR technology is highly immersive and interactive and can bring novel perceptual and experiential modes for users. Therefore, the VR/AR technology is considered as one of important directions of information technology in the future.

A current issue is that after a head-mounted device is worn and fixed, a user's face is subjected to excessive pressure due to integration of key functional components within the device.

### SUMMARY

Embodiments of this application provide a head-mounted device.

An embodiment of this application provides a head-mounted device, including:

a first assembly, where a display function module is disposed on the first assembly;

a second assembly, where an auxiliary module of the display function module is disposed on the second assembly, and the auxiliary module is electrically connected to the display function module;

a connecting mechanism, configured to connect the first assembly and the second assembly, where in a case that the head-mounted device is in a first working state, the second assembly is capable of moving relative to the first assembly along the direction of gravity via the connecting mechanism;

a first strap, where the first strap is connected to the first assembly;

a second strap, where the second strap is connected to the second assembly; and

a first connecting member disposed between the first strap and the second strap, where two ends of the first connecting member are respectively connected to the first strap and the second strap.

### BRIEF DESCRIPTION OF DRAWINGS

FIG. 1 is a first schematic diagram of an exploded structure of a head-mounted device according to an embodiment of this application;

FIG. 2 is a second schematic diagram of an exploded structure of a head-mounted device according to an embodiment of this application;

FIG. 3 is a first schematic cross-sectional diagram of a head-mounted device according to an embodiment of this application;

FIG. 4 is a first schematic diagram of a partial structure of a head-mounted device according to an embodiment of this application;

FIG. 5 is a second schematic diagram of a partial structure of a head-mounted device according to an embodiment of this application;

FIG. 6 is a second schematic sectional diagram of a head-mounted device according to an embodiment of this application;

FIG. 7 is a schematic first diagram of wearing a head-mounted device according to an embodiment of this application;

FIG. 8 is a second schematic diagram of wearing a head-mounted device according to an embodiment of this application;

FIG. 9 is a schematic diagram of an exploded structure of a fastening apparatus of a head-mounted device according to an embodiment of this application;

FIG. 10 is a schematic diagram of a partial structure of a fastening apparatus of a head-mounted device according to an embodiment of this application;

FIG. 11 is a schematic diagram of an overall structure of a fastening apparatus of a head-mounted device according to an embodiment of this application;

FIG. 12 is a schematic diagram of an overall structure of a head-mounted device according to an embodiment of this application;

FIG. 13 is a second schematic cross-sectional diagram of a head-mounted device according to an embodiment of this application; and

FIG. 14 is a third schematic cross-sectional diagram of a head-mounted device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application.

In the specification and claims of this application, the terms "first", "second", and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by "first" and "second" are usually of a same type, and the number of objects is not limited. For example, there may be one or more first objects. In addition, in the specification and claims, "and/or" represents at least one of connected objects, and a character "/" generally represents an "or" relationship between associated objects.

With reference to the accompanying drawings, the following describes in detail the head-mounted device provided in the embodiments of this application by using specific embodiments and application scenarios thereof.

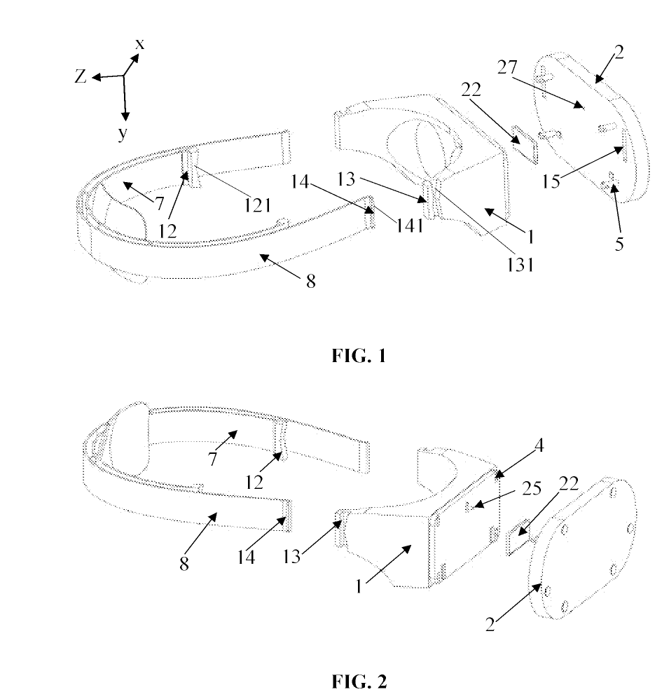

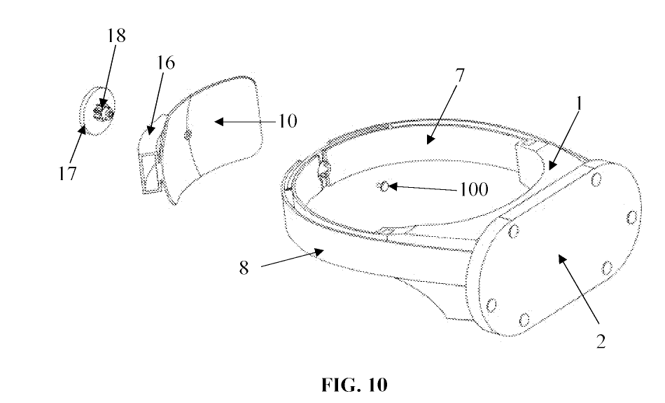

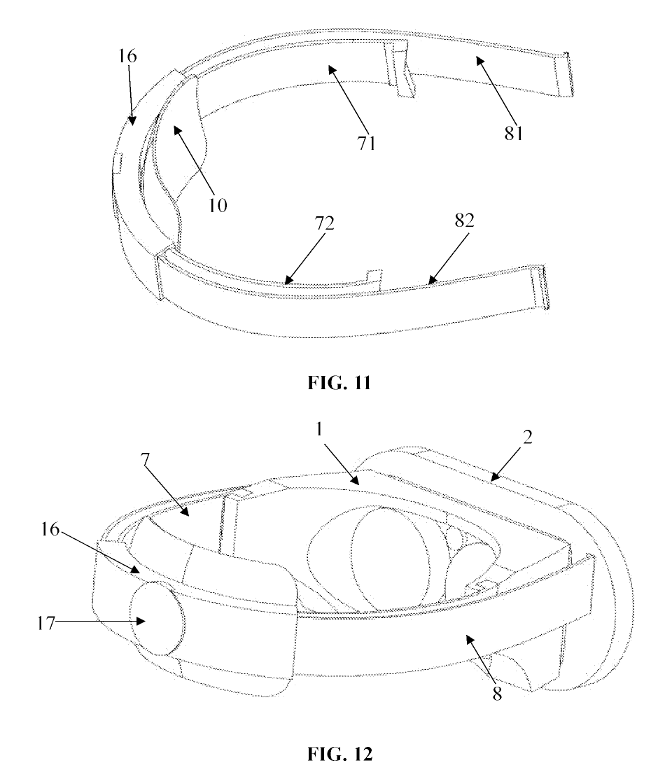

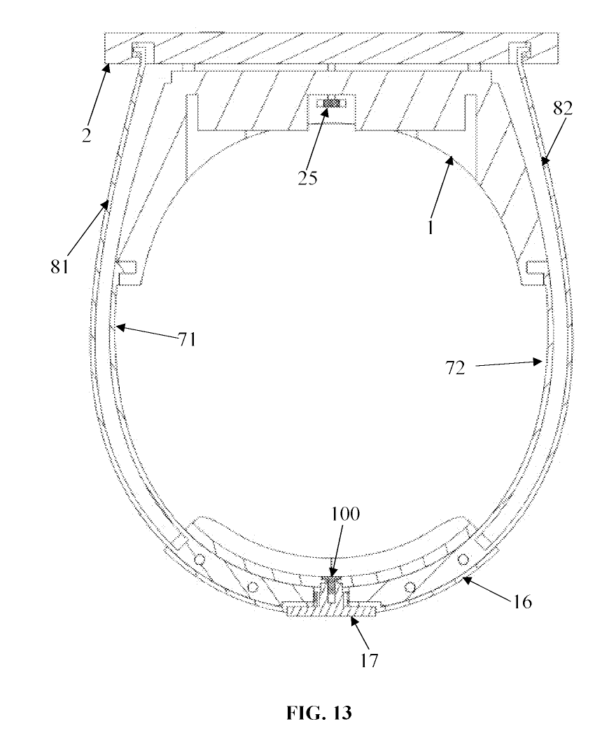

As shown in FIG. 1 to FIG. 14, an embodiment of this application provides a head-mounted device. The head-mounted device includes:

a first assembly 1, where a display function module is disposed on the first assembly 1; a second assembly 2, where an auxiliary module of the display function module is disposed on the second assembly 2, and the auxiliary module is electrically connected to the display function module; and a connecting mechanism, configured to connect the first assembly 1 and the second assembly 2, where in a case that the head-mounted device is in a first working state, the second assembly 2 is capable of moving relative to the first assembly 1 along the direction of gravity via the connecting mechanism. In other words, the first assembly 1 and the second assembly 2 are separated, and active connection between the first assembly 1 and the second assembly 2 may be implemented via the connecting mechanism. To enable the first assembly 1 and the second assembly 2 to be worn on the head of the human body, referring to FIG. 1 to FIG. 5, the head-mounted device further includes: a first strap 7, where the first strap 7 is connected to the first assembly 1; a second strap 8, where the second strap 8 is connected to the second assembly 2; and a first connecting member 9 disposed between the first strap 7 and the second strap 8, where two ends of the first connecting member 9 are respectively connected to the first strap 7 and the second strap 8.

Specifically, the second assembly 2 is disposed on one side of the first assembly 1 away from the first strap 7, the second assembly 2 and the second strap 8 are enclosed to form an accommodation space, and the first strap 7 and the first assembly 1 are disposed on an inner side of the accommodation space.

It should be noted that, the first strap 7 serves as a support carrier after being connected and fixed to the first assembly 1, the second strap 8 is suspended externally, and the second assembly 2 is hung on the second strap 8, and a weight of the second assembly 2 imposes gravity on the second strap 8. Due to a larger cross-section moment of the strap in the direction of gravity, gravity impact of the second assembly 2 can be effectively resisted, resulting in a smaller deformation displacement.

Optionally, the first connecting member 9 is an elastic connecting member, and a plurality of first connecting members 9 are spaced apart between the first strap 7 and the second strap 8. Herein, the plurality of first connecting members 9 are elastic connecting members and are spaced apart between the first strap 7 and the second strap 8. In this way, gravity impact of the second assembly 2 can be further resisted, and stability of the second assembly 2 relative to the first assembly 1 during movement along the direction of gravity is maintained.

If the head-mounted device further includes an eye movement function module, the eye movement function module is disposed on the first assembly 1. If the head-mounted device further includes a display drive module, the display drive module is disposed on the first assembly 1. Optionally, the first assembly 1 is further provided with a display drive module and/or an eye movement function module that are connected to the display function module.

It should be understood that the auxiliary module is a function module that does not necessarily bear force on the face, and the auxiliary module includes but is not limited to a camera, a processor, an antenna, a cooling fan, and a battery. The auxiliary module is integrated on the second assembly 2.

In this embodiment of this application, by separating the first assembly that necessarily bears force on the face from the second assembly, force of the second assembly can be transferred to a position other than the face, so that force on the face can be reduced, and force on the front and force on the rear of the head-mounted device are relatively balanced, thereby improving user's wearing experience.

In an optional embodiment, the connecting mechanism includes:

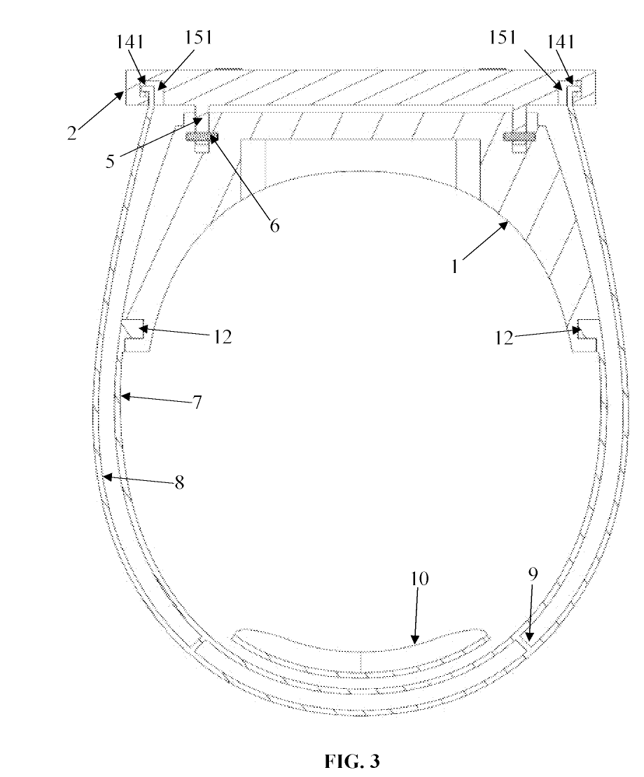

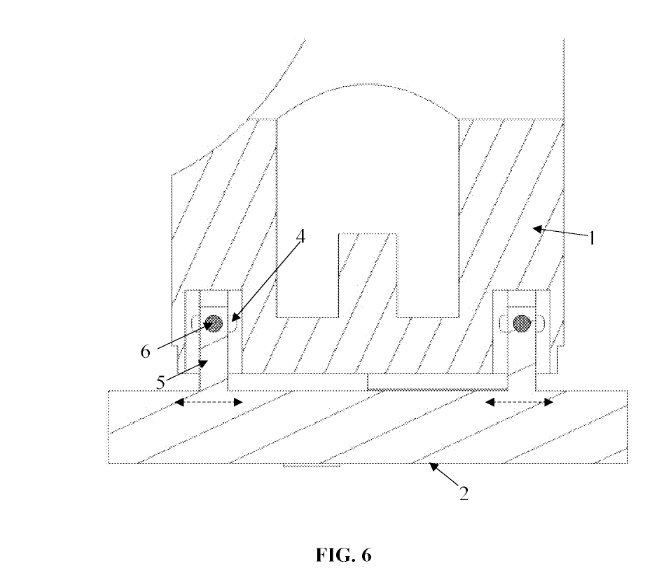

a guide rail groove 4, disposed on one of the first assembly 1 and the second assembly 2; and a guide column 5, disposed on the other one of the first assembly 1 and the second assembly 2, where the guide column 5 is provided with a guide member 6. Specifically, referring to FIG. 2, FIG. 3, and FIG. 5, the guide rail groove 4 is disposed on a first surface of the first assembly 1, and the first surface is opposite to the second assembly 2. The guide column 5 is disposed on a second surface of the second assembly 2, and the second surface is opposite to the first assembly 1.

The guide member 6 is located within the guide rail groove 4, and the guide column 5 is slidable along the guide rail groove 4 via the guide member 6, so that the second assembly 2 moves relative to the first assembly 1 along the direction of gravity.

It should be noted that a first opening communicating with the guide rail groove 4 is disposed on the first assembly 1 or the second assembly 2 that is provided with the guide rail groove 4, and the first opening is configured to allow the guide column 5 and the guide member 6 to extend into the guide rail groove 4. Specifically, the guide column 5 can rotate about a central axis, the guide member 6 is parallel to the direction of gravity by rotating the guide column 5, and the guide column 5 and the guide member 6 extend into the guide rail groove 4 via the first opening. Then, the guide member 6 is perpendicular to the direction of gravity by rotating the guide column 5, so that the guide column 5 is slidable along the guide rail groove 4 via the guide member 6.

Optionally, the guide member 6 is a roller. In this way, a friction coefficient and friction force are reduced through rolling friction of the roller, and interference from force exerted by the second assembly 2 on the first assembly 1 in the direction of gravity (a vertical Y-direction hereinafter) is reduced.

Because the guide rail groove 4 is matched with the guide column 5, a quantity of guide rail grooves 4 is the same as a quantity of guide columns 5. Specifically, at least three guide rail grooves 4 are disposed. In this way, not only relative movement between the second assembly 2 and the first assembly 1 can be implemented, but also stability of connection between the first assembly 1 and the second assembly 2 can be enhanced.

When three guide rail grooves 4 are disposed, the three guide rail grooves 4 may be distributed on the first surface in a triangular manner. Referring to FIG. 5, four guide rail grooves 4 are disposed, and the four guide rail grooves 4 are distributed at four end portions of the first surface in a rectangular manner.

Herein, referring to FIG. 5, a track of the guide rail groove 4 is constrained in a horizontal X-direction and a front-rear Z-direction, but is movable in a vertical Y-direction (the direction of gravity) within a range of ±10 mm, as shown in FIG. 6. This ensures constrained movement and maintains relative integrity between the first assembly 1 and the second assembly 2, preventing excessive misalignment in the vertical Y-direction that could affect appearance.

In an optional embodiment, the head-mounted device in this embodiment of this application further includes:

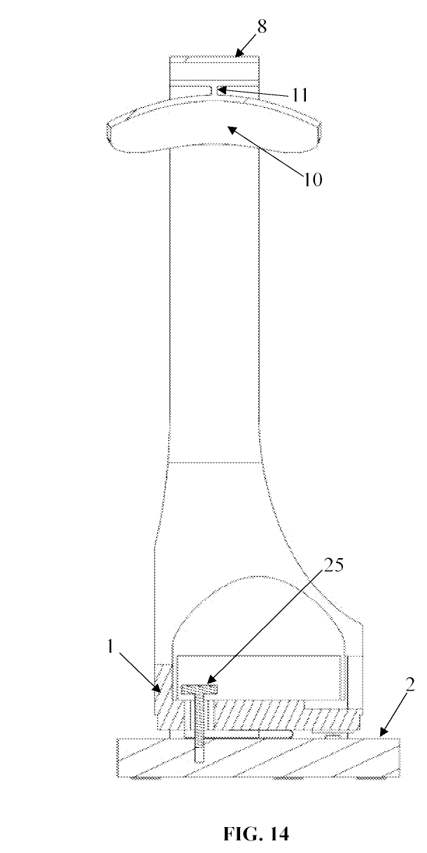

a rear pillow 10, where the rear pillow 10 is disposed between the first strap 7 and the first assembly 1, and the rear pillow 10 is connected to the first strap 7 via a support member 11. For details, refer to FIG. 14.

It should be noted that the rear pillow 10 is a curved three-dimensional structure. After the user wears the head-mounted device, the rear pillow 10 is configured to conform to an occipital bone of the user's head.

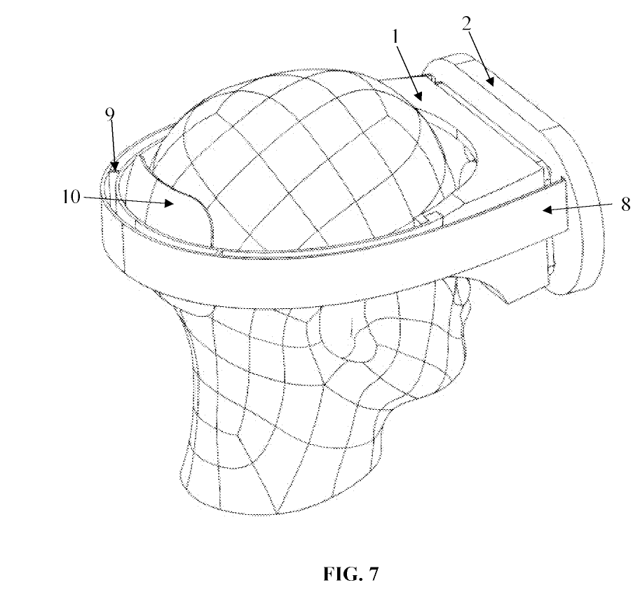

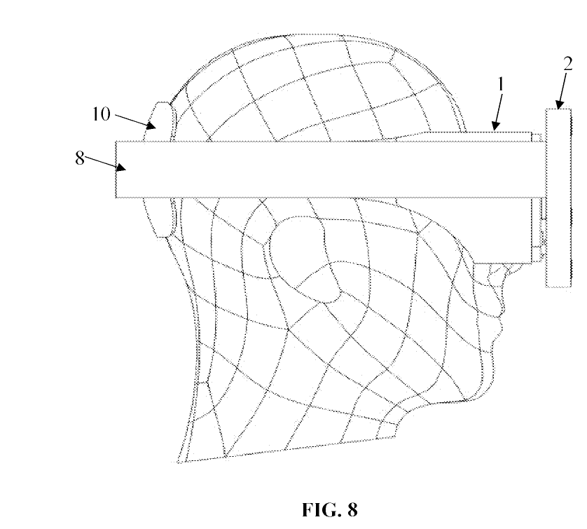

Referring to FIG. 7 and FIG. 8, the second assembly 2 is naturally suspended on an outer side of the second strap 8 due to gravity. In an upright state of the human body, the gravity of the second assembly 2 is directly transferred to the outer side of the second strap 8 and then transferred to the rear pillow 10 (C-shaped pillow), thereby reducing force on the face. During lie-down, the gravity of the second assembly 2 is partially transferred to the first assembly 1.

Referring to FIG. 8, the second strap 8 resembles a cantilever beam structure. The rear pillow 10 conforms to the occipital bone. After the first strap 7 is tightened, force in a plurality of directions is fixed, allowing the second strap 8 to serve as a fulcrum.

In an optional embodiment, an end portion of the first strap 7 is detachably connected to the first assembly 1 via a first snap-fit connection structure; and/or an end portion of the second strap 8 is detachably connected to the second assembly 2 via a second snap-fit connection structure.

Herein, the first strap 7 and the second strap 8 are designed to be detachable and can function as independent components for easy replacement.

Specifically, referring to FIG. 1, the first snap-fit connection structure includes a first hook member 12 and a first clasp member 13 that are detachably connected. The first clasp member 13 is disposed on the first assembly 1 and the first clasp member 13 has a first recess 131 opening outward along a first direction of the device. The first hook member 12 is disposed at the end portion of the first strap 7 and has a first protrusion 121 bent inward along the first direction, and the first protrusion 121 is inserted into the first recess 131 to connect the first strap 7 to the first assembly 1. The first direction (the horizontal X-direction) is a direction perpendicular to the direction of gravity (the vertical Y-direction).

Herein, fastening positioning in the vertical Y-direction (the direction of gravity) and the front-rear Z-direction is implemented after the first hook member 12 is engaged with the first clasp member 13, and no structural limitation is imposed on the horizontal X-direction.

Specifically, referring to FIG. 1 and FIG. 3, the second snap-fit connection structure includes a second hook member 14 and a second clasp member 15 that are detachably connected. The second clasp member 15 is disposed on the second assembly 2 and the second clasp member 15 has a second recess 151 opening along a second direction of the device and bent outward along a first direction of the device. The second hook member 14 is disposed at the end portion of the second strap 8 and has a second protrusion 141 bent outward along the first direction. The second protrusion 141 is inserted into the second recess 151 to connect the second strap 8 and the second assembly 2. The first direction (the horizontal X-direction) is a direction perpendicular to the direction of gravity (the vertical Y-direction), and the second direction is the direction of gravity.

Herein, suspension positioning in the vertical-Y direction is implemented after the second hook member 14 is engaged with the second clasp member 15.

Referring to FIG. 3, it should be noted that when the second protrusion 141 is located within the second recess 151, there is an activity space between the second protrusion 141 and the second recess 151 in a third direction, and the third direction is respectively perpendicular to the first direction and the second direction. That is, the third direction is the front-rear Z-direction.

It should be noted that, in the third direction, there is an activity space between the second protrusion 141 and the second recess 151 in the third direction, that is, there is a front-rear activity space in the Z direction, so that interference to the second assembly 2 is reduced when the second strap 8 is deformed, thereby avoiding collision pressure.

Herein, sizes of the two straps in the direction of gravity (the vertical Y-direction) are greater than sizes in the horizontal direction (the horizontal X-direction) and the front-to-rear direction (the front-to-rear Z direction). In this way, a cross-section of the strap is similar to a long rectangle, so that a cross-section moment in the Y-direction is large, and a position can be maintained. Cross-section moments in the X-direction and the Z-direction are small, allowing for elastic deformation.

The first strap 7 is connected to the first assembly 1, and the second strap 8 is connected to the second assembly 2. An inner ring formed by the first strap 7 and the first assembly 1 is elastically deformed via the first strap 7, and is worn on the head of the human body after the user pulls out by hand. After being worn, the ring is elastically restored, and the head-mounted device is fixed to the head of the human body. An outer ring formed by the second strap 8 and the second assembly 2 is suspended on the second strap 8 by gravity of the second assembly 2 in the Y-direction (the direction of gravity). Because a cross-section moment in the Y-direction is large, the outer side of the second strap 8 subjected to gravity of the second assembly 2 has small deformation, and a relative position between the first assembly 1 and the second assembly 2 can be better maintained.

Herein, a fastening apparatus formed by the first strap 7 and the second strap 8 in this embodiment may be of a plurality of specification models, to better meet requirements of different populations.

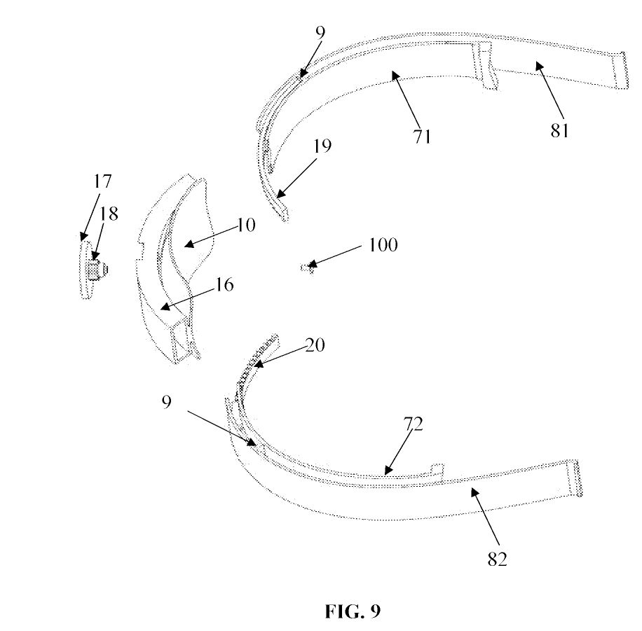

In another optional embodiment, referring to FIG. 9 to FIG. 13, the head-mounted device in this embodiment of this application further includes:

a first knob 17 and a connecting portion 16 with two open ends, where a gear 18 is disposed on the first knob 17; and the first strap 7 includes a first part 71 and a second part 72, and the second strap 8 includes a third part 81 and a fourth part 82. One end portion of the first part 71 and one end portion of the second part 72 are respectively detachably connected to the first assembly 1; one end portion of the third part 81 and one end portion of the fourth part 82 are respectively detachably connected to the second assembly 2; the other end portion of the first part 71 and/or the other end portion of the third part 81 are provided with a first rack 19; and the other end portion of the second part 72 and/or the other end portion of the fourth part 82 are provided with a second rack 20.

It should be noted that the first rack 19 may be disposed at the other end portion of the first part 71 of the first strap 7, or the first rack 19 may be disposed at the other end portion of the third part 81 of the second strap 8; or the first rack 19 is disposed on the other end portion of the first part 71 and the other end portion of the third part 81, that is, the first rack 19 is connected to the other end portion of the first part 71 and the other end portion of the third part 81. Specifically, the first rack 19 may be fastened to the other end portion of the first part 71 and/or the other end portion of the third part 81 in a fastening manner such as screwing or riveting. Alternatively, the first rack 19 is disposed on one first connecting member 9 connected to the first strap 7 and the second strap 8.

The second rack 20 may be disposed at the other end portion of the second part 72 of the first strap 7, or the second rack 20 may be disposed at the other end portion of the fourth part 82 of the second strap 8; or the second rack 20 is disposed at the other end portion of the second part 72 and the other end portion of the fourth part 82, that is, the second rack 20 is connected to the other end portion of the second part 72 and the other end portion of the fourth part 82. Specifically, the second rack 20 may be fastened to the other end portion of the second part 72 and/or the other end portion of the fourth part 82 in a fastening manner such as screwing or riveting. Alternatively, the second rack 20 is disposed on another first connecting member 9 connected to the first strap 7 and the second strap 8.

The first rack 19 and the second rack 20 are inserted into the connecting portion 16; the gear 18 is engaged with the first rack 19 and the second rack 20; and a length of the first strap 7 and a length of the second strap 8 are adjusted via a combination of the gear 21, the first rack 19, and the second rack 20.

After the first rack 19 and the second rack 20 are inserted into the connecting portion 16, a tooth on the first rack 19 is opposite to a tooth on the second rack 20, and a space for engagement with the gear 21 is reserved between the first rack 19 and the second rack 20.

Herein, after the gear 21 on the first knob 17 is engaged with the first rack 19 and the second rack 20 via the connecting portion 16, the first knob 17 is connected via a threaded second connecting member 100. By rotating the first knob 17, the first knob 17 is screwed into or out of the second connecting member 100. In this case, the gear 21 cooperates with the first rack 19 and the second rack 20, so that a length of a strap component composed of the first strap 7 and the second strap 8 is shortened or lengthened, thereby adjusting the length of the strap component composed of the first strap 7 and the second strap 8, so as to match needs of more people.

It should be understood that, the strap component composed of the first strap 7 and the second strap 8 in this embodiment is formed by breaking the first strap 7 and the second strap 8 in the foregoing embodiment in the middle respectively and the strap component is formed through combination by adding a corresponding component. That is, end portion structures of the first strap 7 and the second strap 8 are the same as those in the foregoing embodiment, and details are not described herein again.

Optionally, one side that is of the connecting portion 16 with two open ends and that is close to the first assembly 1 is provided with a rear pillow 10.

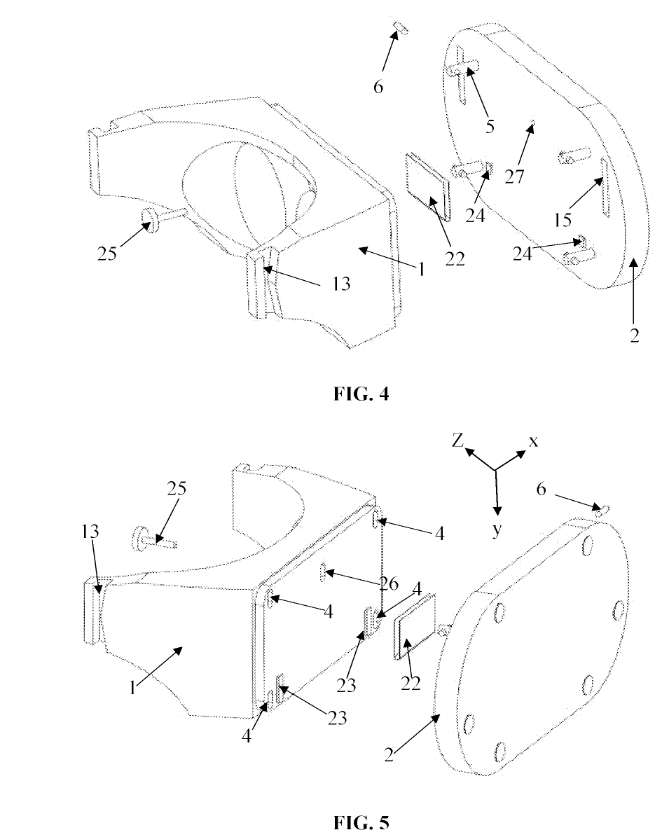

Optionally, the head-mounted device in this embodiment of this application further includes a flexible circuit board 22, and the second assembly 2 is electrically connected to the first assembly 1 via the flexible circuit board 22, referring to FIG. 1, FIG. 2, FIG. 4, and FIG. 5.

In an optional embodiment, the head-mounted device in this embodiment of this application further includes a position detection apparatus, where the position detection apparatus is configured to detect a displacement of the second assembly 2 relative to the first assembly 1.

The position detection apparatus is disposed on the head-mounted device in this embodiment of this application, so that the displacement of the second assembly 2 relative to the first assembly 1 is detected, and this displacement parameter is provided for a processor of the head-mounted device. Subsequently, a performance requirement and an algorithm requirement may be compensated, thereby improving device performance. For example, because the second assembly 2 can move relative to the first assembly 1 along the direction of gravity, an image captured by a camera disposed on the second assembly 2 may experience shaking. The displacement detected by the position detection apparatus is provided for the processor of the head-mounted device. Based on this displacement, the processor performs algorithmic compensation to achieve optical image stabilization for the camera, thereby ensuring stable image output from the display function module on the first assembly 1.

Optionally, the position detection apparatus includes a magnetic element 23 disposed on the first assembly 1; and a magnetic induction component 24 disposed on the second assembly 2. When the second assembly 2 moves relative to the first assembly 1 along the direction of gravity, the magnetic induction component 24 cooperates with the magnetic element 23 to detect the displacement of the second assembly 2 relative to the first assembly 1.

Specifically, the magnetic element 23 may be a long strip magnet. The magnetic element 23 on the first assembly 1 and the magnetic induction component 24 on the second assembly 2 cooperate to detect a deformation position and a displacement of the second assembly 2.

In an optional embodiment, the head-mounted device in this embodiment of this application further includes:

a locking apparatus 25, where in a case that the head-mounted device is in a second working state, the second assembly 2 is locked relative to the first assembly 1 along the direction of gravity via the locking apparatus 25; and the locking apparatus 25 is configured to enable the head-mounted device to switch between the first working state and the second working state.

Optionally, the locking apparatus 25 is a fastener. A first mounting hole 26 is disposed on the first assembly 1, and a second mounting hole 27 is disposed on the second assembly 2. In a case that the head-mounted device is in the second working state, the fastener locks the second assembly 2 and the first assembly 1 via the first mounting hole 26 and the second mounting hole 27. In a case that the head-mounted device is in the first working state, the fastener is separated from the first mounting hole 26 and the second mounting hole 27.

Specifically, the fastener has an external thread. Correspondingly, the first mounting hole 26 is a through hole, referring to FIG. 5. The second mounting hole 27 is a blind hole with an internal thread, referring to FIG. 4. Specifically, the fastener cooperates with the internal thread on the second mounting hole 27 through the first mounting hole 26, to lock and separate the first assembly 1 and the second assembly 2.

It should be noted that, in a case that the head-mounted device is in the second working state, after the first assembly 1 and the second assembly 2 are locked via the locking apparatus 25, the first assembly 1 and the second assembly 2 are integrated to meet some specific requirements. For example: (a) A problem that a service life of the head-mounted device decreases due to prolonged relative movement of the first assembly 1 and the second assembly 2 in a transport process of the head-mounted device can be avoided. (b) To meet wearing requirements of users, for example, some users prefer to fasten the head-mounted device to the head via a flexible strap, the first assembly 1 and the second assembly 2 are fastened together. (c) When no strap is mounted on the head-mounted device, temporary fixation may be implemented. (d) In a scenario of intense movement, if a deformation of the second strap 8 cannot meet a performance requirement, the first assembly 1 and the second assembly 2 are locked together to meet a basic function requirement of the head-mounted device.

In the head-mounted device in this embodiment of this application, the display function module disposed on the first assembly is electrically connected to the auxiliary module that is of the display function module and that is disposed on the second assembly. In a case that the head-mounted device is in the first working state, the second assembly is capable of moving relative to the first assembly along the direction of gravity via the connecting mechanism that connects the first assembly and the second assembly. In this way, by separating the first assembly that necessarily bears force on the face from the second assembly, force of the second assembly can be transferred to a position other than the face, so that force on the face can be reduced, and force on the front and force on the rear of the head-mounted device are relatively balanced, thereby improving user's wearing experience. In addition, the first strap is connected to the first assembly; the second strap is connected to the second assembly; and the first connecting member is disposed between the first strap and the second strap, and the two ends of the first connecting member are respectively connected to the first strap and the second strap, so that the first assembly and the second assembly can be worn on the head of the human body.

It should be noted that, in this specification, the terms "include", "comprise", or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by "includes a ..." does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the above specific implementations, and the above specific implementations are merely illustrative but not restrictive.

What is claimed is:

1. A head-mounted device, comprising:
a first assembly, wherein a display function module is disposed on the first assembly;
a second assembly, wherein an auxiliary module of the display function module is disposed on the second assembly, and the auxiliary module is electrically connected to the display function module;
a connecting mechanism, configured to connect the first assembly and the second assembly, wherein in a case that the head-mounted device is in a first working state, the second assembly is capable of moving relative to the first assembly along the direction of gravity via the connecting mechanism;
a first strap, wherein the first strap is connected to the first assembly;
a second strap, wherein the second strap is connected to the second assembly; and
a first connecting member disposed between the first strap and the second strap, wherein two ends of the first connecting member are respectively connected to the first strap and the second strap.

2. The head-mounted device according to claim 1, wherein the connecting mechanism comprises:
a guide rail groove, disposed on one of the first assembly or the second assembly; and
a guide column, disposed on the other one of the first assembly of the second assembly, wherein the guide column is provided with a guide member, wherein
the guide member is located within the guide rail groove, and the guide column is slidable along the guide rail groove via the guide member, so that the second assembly moves relative to the first assembly along the direction of gravity.

3. The head-mounted device according to claim 1, wherein the first connecting member is an elastic connecting member, and a plurality of the first connecting members are spaced apart between the first strap and the second strap.

4. The head-mounted device according to claim 1, wherein the second assembly is disposed on one side of the first assembly away from the first strap, the second assembly and the second strap are enclosed to form an accommodation space, and the first strap and the first assembly are disposed on an inner side of the accommodation space.

5. The head-mounted device according to claim 1, wherein an end portion of the first strap is detachably connected to the first assembly via a first snap-fit connection structure, and the first snap-fit connection structure comprises a first hook member and a first clasp member that are detachably connected, wherein
the first clasp member is disposed on the first assembly, and the first clasp member has a first recess opening outward along a first direction of the device; the first hook member is disposed at the end portion of the first strap and has a first protrusion bent inward along the first direction, and the first protrusion is inserted into the first recess to connect the first strap and the first assembly; and the first direction is a direction perpendicular to the direction of gravity.

6. The head-mounted device according to claim 1, wherein an end portion of the second strap is detachably connected to the second assembly via a second snap-fit connection structure, and the second snap-fit connection structure comprises a second hook member and a second clasp member that are detachably connected, wherein
the second clasp member is disposed on the second assembly and the second clasp member has a second recess opening along a second direction of the device and bent outward along a first direction of the device; and
the second hook member is disposed at the end portion of the second strap and has a second protrusion bent outward along the first direction; the second protrusion is inserted into the second recess to connect the second strap and the second assembly; and the first direction is a direction perpendicular to the direction of gravity, and the second direction is the direction of gravity.

7. The head-mounted device according to claim 3, further comprising a first knob and a connecting portion with two open ends, wherein a gear is disposed on the first knob; and
the first strap comprises a first part and a second part, and the second strap comprises a third part and a fourth part; one end portion of the first part and one end portion of the second part are respectively detachably connected to the first assembly; one end portion of the third part and one end portion of the fourth part are respectively detachably connected to the second assembly; the other end portion of the first part and/or the other end portion of the third part are provided with a first rack; and the other end portion of the second part and/or the other end portion of the fourth part are provided with a second rack, wherein
the first rack and the second rack are inserted into the connecting portion; the gear is engaged with the first rack and the second rack; and a length of the first strap and a length of the second strap are adjusted via a combination of the gear, the first rack, and the second rack.

8. The head-mounted device according to claim 1, further comprising:
a position detection apparatus, wherein the position detection apparatus is configured to detect a displacement of the second assembly relative to the first assembly.

9. The head-mounted device according to claim 1, further comprising:
a locking apparatus, wherein in a case that the head-mounted device is in a second working state, the second assembly is locked relative to the first assembly along the direction of gravity via the locking apparatus; and the locking apparatus is configured to enable the head-mounted device to switch between the first working state and the second working state.

10. The head-mounted device according to claim 1, wherein the first assembly is further provided with a display drive module and/or an eye movement function module connected to the display function module.
